(19) United States
(12) Patent Application Publication
(10) Pub. No.: US 2008/0285432 A1
(43) Pub. Date: Nov. 20, 2008

(54) Method for Generating Candidates used in Turbo Coded Orthogonal Frequency-Division Multiplexing System with Selective Mapping Technique

(76) Inventors: Yeong-Luh Ueng, Hsin-Chu City (TW); Yung-Chih Tsai, Taipei (TW)

Correspondence Address: HDSL, 4331 STEVENS BATTLE LANE, FAIRFAX, VA, 22033, US

(21) Appl. No.: 11/750,465

(22) Filed: May 18, 2007

(51) Int. Cl. H04J 11/00

(52) U.S. Cl. 370/203; 370/210

(57) ABSTRACT

A method for generating candidate used in TCOFDM (turbo coded orthogonal frequency-division multiplexing) with SLM (selective mapping) technique, a user data is combined with a plurality of seeds to generate corresponding a plurality of message vectors. The method is characterized in performing tail-biting turbo encoding on the message vectors to generate corresponding turbo codewords used for generating candidates, and the seed of each message vector is different from the seeds of other message vectors.

### BACKGROUND OF THE INVENTION

1. Field of Invention

The present invention relates to a method for generating candidates used in TCOFDM (turbo coded orthogonal frequency-division multiplexing) system. More particularly, the present invention relates to a method for generating candidates used in TCOFDM system such that the peak-to-average power ratio (PAPR) can be reduced.

2. Description of Related Art

Turbo coded OFDM (TCOFDM) systems are popular for broadband wireless communications since such systems can provide good error performance. Such systems have been suggested in many standards such as IEEE 802.16e. A well-known disadvantage of an OFDM system is its high peak-to-average power ratio (PAPR) in time-domain signal which results in high out-of-band emission at the output of a nonlinear device such as power amplifier (PA). Hence, low PAPR is highly desired for a TCOFDM system. By now, many techniques have been proposed for relieving the PAPR problem in the OFDM systems. These techniques can be divided into two categories, the distortion-based techniques and the redundancy-based techniques.

Some of the existing distortion-based techniques are described as follows:

OCF (“New OFDM peak-to-average power reduction scheme,” J. Armstrong, Proc. IEEE Vehicular Technology Conference, May 2001) is implemented by clipping the high peak of the over-sampled signal and filtering off the out-of-band emission. OCF can be implemented by using digital signal processing. However, the filtered signal has the phenomenon of peak power re-growth.

Recursive (repeated) clipping and filtering (RCF) (“Peak-to-average power reduction for OFDM by repeated clipping and frequency domain filtering,” J. Armstrong, Electronics Letters, Vol. 38, No. 5, February 2002) is proposed to overcome the peak power re-growth problem. By increasing the number of recursions, RCF could effectively reduce the PAPR and out-of-band emission. But the severe distortion caused by clipping is the resultant problem.

Active constellation extension (ACE) (“PAR reduction in OFDM via active constellation extension,” B. S. Krongold and D. L. Jones, IEEE Trans. Broadcasting, Vol. 49, pp. 258-268, September 200) modifies RCF by allowing the signal points at the edge of the constellation to be distorted in the direction away from the edge. The distortion is less than the RCF, but the gain of PAPR is diminished. Although the distortion-based techniques can reduce the PAPR significantly, the resultant in-band distortion is also significant.

Another category of PAPR reduction techniques is redundancy-based techniques. Some of existing methods are described as follows.

Selective mapping (SLM) (“Reducing the peak-to-average power ratio of multi-carrier modulation by selected mapping,” R. W. Bauml, R. F. H. Fischer, and J. B. Huber, Electronic Letters, Vol .32, pp. 2056-2057, October 1996, “SLM peak-power reduction without explicit side information,” M. Breiling, S. H. Muller-Weinfurtner and J. Huber, IEEE Comm. Letter., vol. 5, pp. 239-241, June 2001.) is implemented by generating multiple OFDM symbols as candidates for the same message and then choosing the one with minimum PAPR from these candidates for actual transmission.

In SLM, side information (SI) is needed to tell the receiver which candidate is used at the transmitter. The bandwidth efficiency is reduced for the transmission of SI. In addition, incorrect decision of SI will result in error propagation and hence serious degradation in error performance.

### SUMMARY OF THE INVENTION

The invention is to provide a method for generating candidates used in turbo coded orthogonal frequency-division multiplexing (TCOFDM) system with selective mapping (SLM) technique. The method reserves some message bits in a tail-biting turbo code for generating candidates used in SLM. Different candidates for the same user data are generated by using different reserved message bits. With such generation of candidates, SLM can be implemented without explicit SI to reduce PAPR.

The invention is to provide a method for generating candidates used in TCOFDM with SLM technique such that the error performance of RCF can be improved.

The invention provides a method for generating candidates used in TCOFDM with SLM technique, wherein a user data is combined with a plurality of seeds to generate corresponding a plurality of message vectors. The method is characterized in performing tail-biting turbo encoding on each of the message vectors to generate corresponding turbo codeword used for generating candidate, wherein the seed of each message vector is different from the seeds of other message vectors.

In one embodiment, the turbo codeword is generated by using steps including: encodes the message vector ū with zero initial state by using an encoder of a first constituent code to get a final state

$${s}_{M} = {\sum }_{n = 0}^{M - 1} {A}^{( M - 1 ) - n} {Bu}_{n} ,$$

wherein the message vector ū={u₀,u₁,Λ, u_{M-1}} and uₙ is a binary k×1 vector at time n, a state-space representation of the first constituent code is sₙ₊₁=Asₙ+Buₙ, where sₙ₊₁ and sₙ are m×1 state vectors of the encoder at time n+1 and n, respectively, m denotes the number of memory bits in the encoder of the first constituent code, A is m×m state matrix, and B is m×k control matrix; derives a new initial state s′₀ from (A^{M}+Iₘ)s′₀=Σₙ₌₀^{M-1} A^{(M-1)-n}Buₙ=s_{M} with s′₀=s′_{M} and

$${s}_{M} = {\sum }_{n = 0}^{M - 1} {A}^{( M - 1 ) - n} {Bu}_{n} ,$$

where Iₘ is an m×m identity matrix; encodes the message vector ū with the new initial state s′₀ to generate the codeword of the first constituent code; encodes the message vector ū with initial state s′₀ by using an encoder of a second constituent code to generate the codeword of the second constituent code; and generates the turbo codeword in accordance to the codeword of the first constituent code and the codeword of the second constituent code.

The present invention further provides a method for generating candidates used in TCOFDM with SLM technique. In one embodiment, a user data is combined with a plurality of seeds to generate corresponding a plurality of message vectors, tail-biting turbo encoding is performed on the message vectors to generate corresponding turbo codewords, and a plurality of frequency-domain symbol-sequences are generated in accordance to the turbo codewords and each of them is converted to corresponding one time-domain candidate. After that, one of the time-domain candidates is chosen as a candidate used in actual data transmission, wherein the seed of each message vector is different from the seeds of other message vectors.

In one embodiment, while converting each of the frequency-domain symbol-sequences to corresponding one time-domain candidate, PAPR (peak-to-average power reduction) operation, including inverse fast Fourier transform operation, power compensation operation, clipper operation, fast Fourier transform operation and filtering operation, is performed on each of the frequency-domain symbol sequences repeatedly.

In one embodiment, the power compensation operation is performed between the inverse fast Fourier transform operation and the clipper operation. Furthermore, the power compensation operation compensates power loss by applying the formula x′ᵢ=(|xᵢ|+Ap)e^{jθ}^{ᵢ},0≦i−LN−1, Ap≧0, wherein LN is a point number used for performing the inverse fast Fourier transform operation, L is an over-sampling factor, N is the tone number of OFDM system, and x′ᵢ is an element of an output signal x′ obtained after performing power compensation operation on a signal xᵢ≡|xᵢ|e^{jθ}^{ᵢ}, x=(x₀,x₁,Λ, x_{LN-1}).

In one embodiment, the above mentioned time-domain candidate with minimum peak-to-average power ratio is chosen as the candidate. In another embodiment, the time-domain candidate with minimum distortion is chosen as the candidate.

The present invention further provides a method for performing PAPR reduction, which is characterized in performing a deliberate power boost by using x′ᵢ=(|xᵢ|+Ap)e^{jθ}^{ᵢ},0≦i≦N−1, Ap≧0, wherein x=(x₀,x₁,Λ,x_{N 1}), N is a point number used for performing the inverse fast Fourier transform operation, and x′ᵢ is an element of an output signal x′ obtained after performing the deliberate power boost on a signal xᵢ≡|xᵢ|e^{jθ}^{ᵢ}.

Accordingly, different candidates for the same user data are generated by using different reserved message bits. With such generation of candidates, SLM can be implemented without explicit SI to reduce PAPR, and, no error propagation is observed since there is no need to explicitly decide the SI.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a block diagram of an N-tone turbo coded OFDM (TCOFDM) transmitter in accordance to an embodiment of the present invention.

FIG. 2 shows a block diagram of an N-tone turbo coded OFDM (TCOFDM) transmitter in accordance to an embodiment of the present invention.

FIG. 3 is a block diagram of TCOFDM system using both repeated clipping and filtering (RCF) and deliberate power boost (DPB) in accordance to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

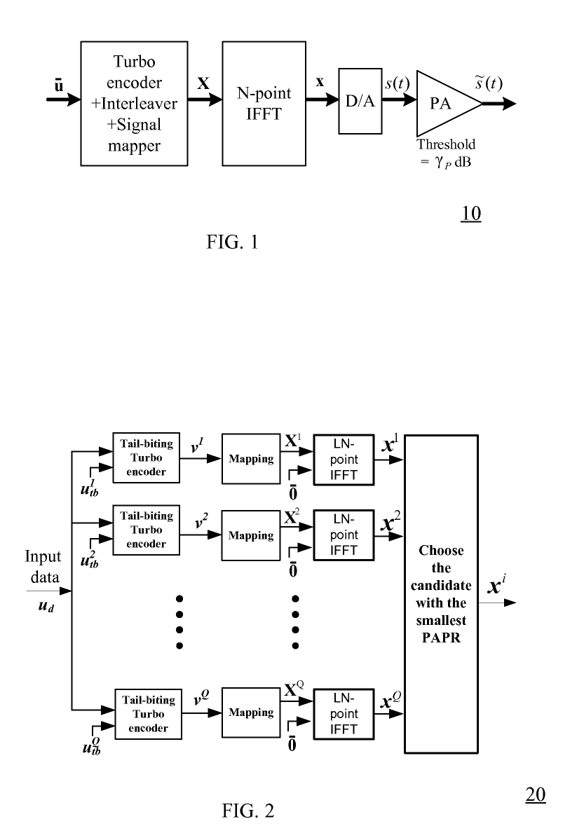

FIG. 1 shows a block diagram of an N-tone turbo coded OFDM (TCOFDM) transmitter in accordance to an embodiment of the present invention. By using the transmitter 10, with turbo encoding, interleaving and signal mapping, a message vector ū can be converted into a complex vector X=(X₀, X₁,Λ, X_{N-1}), where Xₖ is the complex value carried by the k^{th} sub-carrier. The OFDM symbol s(t) at the output of the digital-to-analog converter is represented by

$$s ( t ) = \frac{1}{\sqrt{N}} {\sum }_{k = 0}^{N - 1} {X}_{k} {e}^{j k 2 π Δ f t} , 0 \leq t \leq T \qquad ( 1 )$$

where T is the symbol interval, and Δf=1/T is the frequency spacing between adjacent sub-carriers. The peak power of s(t) may be significantly greater than the average power of the transmitted OFDM symbols. This effect can be measured by the peak-to-average power ratio (PAPR) of s(t) as defined by:

$$PAPR ( s ( t ) ) = \frac{{max}_{0 \leq t \leq T} {\vert s ( t ) \vert}^{2}}{\frac{1}{T} E \{ {\int }_{0}^{T} s ( t ) s * ( t ) d t \}} \qquad ( 2 )$$

where the expectation E{.} is taken over all the possible transmitted OFDM symbols s(t). Signal s(t) is processed by a non-linear PA with a maximum permissible amplitude P and a clipping ratio

$${γ}_{P} = \frac{P}{\sqrt{E [ {‖ s ( t ) ‖}^{2} ]}}$$

to obtain the output signal \tilde{s}(t). Signal s(t) with high PAPR will result in the signal \tilde{s}(t) with high out-of-band emission and high in-band distortion.

The complementary cumulative distribution function (CCDF) for PAPR is the probability Pr(PAPR>λ) which can be approximated well by (1−(1−e^{λ})^{αN} if N is large enough, where λ is a positive constant and α=2.8.

The technique of selective-mapping (SLM) can be used to reduce PAPR. Each message is assigned with Q possible OFDM symbols for transmission, where each OFDM symbol is called a candidate. The transmitter selects the candidate with the smallest PAPR for transmission. In order to recover the transmitted message, the receiver requires the knowledge about which candidate is selected at the transmitter. The side information (SI) is needed in the transmitted symbol such that the receiver can recover the SI and the associated candidate. If the incorrect SI is obtained, the serious error propagation would degrade the system performance. Accordingly, the SI must be protected very well in a conventional SLM technique.

The error propagation mentioned above can be avoided by using the proposed technique of generating candidates in the present invention. In the method, a user data is combined with a plurality of seeds to generate corresponding a plurality of message vectors. After that, tail-biting turbo encoding is performed on the message vectors to generate corresponding turbo codewords used for generating candidates, wherein the seed of each message vector is different from the seeds of other message vectors. A tail-biting turbo code is the same as that of a conventional turbo code except that the first constituent code or/and the second constituent code is encoded in a tail-biting form. The codeword of a tail-biting convolutional code starts from and ends in the same state.

For a rate k/n recursive systematic convolutional (RSC) code, a message vector ū=(u₀,u₁,Λ,w_{M-1}) is encoded with Mk bits in a tail-biting form, where uₙ(0≦n≦(M−1)) is a binary k×1 vector at time n. Let m be the number of memory bits in this RSC encoder. The state-space representation of a RSC code is:

sₙ₊₁=Asₙ+Buₙ (3)

where sₙ₊₁ and sₙ are the m×1 state vectors of the encoder at time n+1 and n, respectively. A is the m×m state matrix, and B is the m×k control matrix. From (3), we have

$${s}_{M} = {A}^{M} {s}_{0} + {\sum }_{n = 0}^{M - 1} {A}^{( M - 1 ) - n} {Bu}_{n} \qquad ( 4 )$$

The encoding procedure can be summarized as two steps:

Step 1-1. Encode the message vector ū with zero initial state, i.e., sₒ=0, to get the final state, i.e.,

$${s}_{M} = {\sum }_{n = 0}^{M - 1} {A}^{( M - 1 ) - n} {Bu}_{n} .$$

The output of the RSC encoder is omitted.

Step 1-2. Encode the message vector ū with a new initial state s′₀. According to tail-biting constraint, s′₀=s′_{M}. Therefore, we can derive s′₀ from equation (4), i.e.,

$$( {A}^{M} + {I}_{m} ) {s}_{0}^{′} = {\sum }_{n = 0}^{M - 1} {A}^{( M - 1 ) - n} {Bu}_{n} = {s}_{M} ,$$

therein Iₘ is an m×m identity matrix. The output of the RSC encoder is the desired codeword of the RSC code.

The tail-biting BCJR algorithm provided by “Tailbiting MAP decoders” (J. B. Anderson and S. M. Hladik, IEEE J. Select. Areas Commun., vol. 16, no. 2, pp. 297-302, February 1998) can be used to decode a tail-biting convolutional code.

FIG. 2 shows a tail-biting TCOFDM system using the tail-biting bits in a tail-biting turbo code to generate Q candidates used in SLM. In the TCOFDM system 20, first, we consider the case that only first constituent code is encoded in a tail-biting form. Let m denote the number of memory bits in first constituent code (or second constituent code). In the tail-biting encoder of first constituent code, we use this m-bit tail to generate Q=2^{m} codewords of the first constituent code for the same user data. Divide the message vector ū=(u_{d},u_{tb}), where u_{d} and u_{tb} are the user date and the m-bit tail (i.e., seed), respectively. Denote these Q=2^{m} possible tails by u_{tb}^{u}, i=1,2,Λ, Q. The m-bit tail u_{tb} is not used to carry user data but is used to generate Q different candidates. The procedure of generating Q candidates is described as follows.

Step 2-1. For i=1,2,Λ,Q, encode (u_{d},u_{tb}ⁱ) with zero initial state by using the encoder of first constituent code to get the ending state s_{M}ⁱ. In general, Q different u_{tb}ⁱ results in Q different s_{M}ⁱ. The output of the encoder of first constituent code is omitted.

Step 2-2. With s_{M}ⁱ and (u_{d},u_{tb}ⁱ), we use Step 1-2 described above to get initial state s′₀ⁱ, i=1,2,Λ, Q. Hence, we have Q tail-biting codewords of first constituent code.

Step 2-3. For i=1,2,Λ,Q, encode (u_{d},u_{tb}ⁱ) with initial state s′₀ⁱ by using the encoder of second constituent code to get a codeword of second constituent code.

Step 2-4. With the codewords of first constituent code and second constituent code, we can obtain Q different turbo codewords v¹, v²,Λ, v^{Q} which can be used as candidates for user data u_{d}.

The cross correlations among turbo codewords v¹, v² ,Λ,v^{Q} are low since the recursive encoders of first constituent code and second constituent code are used as scramblers and an interleaver is embedded in the turbo encoder. If more than 2^{m} candidates are needed for improved PAPR performance, c-bit user date can be used as a part of the seed for obtaining additional candidates.

For example, we can divide u_{d} into (u_{dc},u_{dd}), where u_{dc} ∈{0,1}^{c} is used for candidates generation, and u_{dd} is the remaining (M-m-c)-bit user date. Different u_{dc} can provide different candidates. Hence, a total candidate number of Q =2^{m+c} with low cross correlations can be obtained. The bits in u_{dc} may be nonconsecutive. At the output of the tail-biting turbo decoder, u_{dc} and u_{tb} can be discarded to obtain the desired data bits u_{dd}. Accordingly, no explicit SI is needed in the present invention and better error performance can be obtained.

For deliberate clipping, its high in-band distortion and out-of-band emission can be reduced by over-sampled digital clipping and by digital filters, respectively. This procedure is called over-sampled clipping and filtering (OCF). However, if the out-of-band emission is filtered off, it is likely that the reduced PAPR of the clipped signal will regrow. The PAPR can be improved by repeating (or recursive) clipping and filtering (RCF) several times.

Furthermore, for PAPR reduction, the present invention provides a technique named deliberate power boost (hereinafter, DPB). For x=(x₀, x₁79 , x_{N-1}), which is a time-domain OFDM symbol, as 0≦i≦N−1, let xᵢ≡|xᵢ|e^{jθ}^{ᵢ} and x′ᵢ denote the input and output signals of the DPB, respectively. The operation of DPB with parameter A_{P}>0 can be done according to

x′ᵢ=(|xᵢ|+A_{P})e^{jθ}^{ₜ} for 0≦i≦N−1 (5)

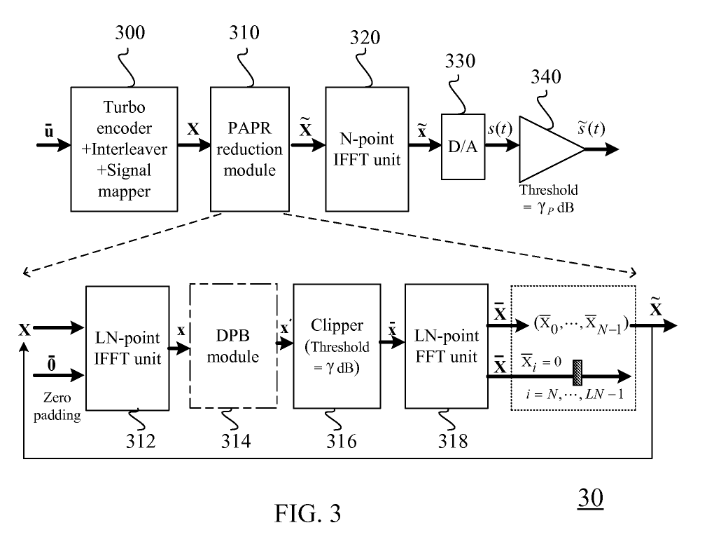

A detailed embodiment for applying the DPB with the RCF is described below. For improved error performance, turbo coding can be applied to such OFDM systems as shown in FIG. 3. Refer to FIG. 3, which is a block diagram of TCOFDM system using both repeated clipping and filtering (RCF) and DPB in accordance to an embodiment of the present invention. In the embodiment, the TCOFDM system 30 includes a Turbo encoder 300 (including interleaver and signal mapper), PAPR reduction module 310, N-point inverse fast Fourier transform (IFFT) unit 320, digital to analog (D/A) converter 330 and amplifier 340. More specifically, a DPB module 314 is used in the PAPR reduction module 310 and, for example, is inserted between LN-point IFFT unit 312 and Clipper 316. The complex vector X input into PAPR reduction module 310 is processed by the LN-point IFFT unit 312, DPB module 314, Clipper 316 and LN-point fast Fourier transform (FFT) unit 318 to generate an frequency-domain signal X̅.

The operation in FIG. 3 is now described with an over-sampling factor of L.

Step 3-1. Append (L−1)N zeros to complex vector X. Then apply LN-point IFFT on the zero-padded complex vector X to generate the over-sampled frequency-domain symbol-sequences x=(x₀, x₁,Λ, x_{LN-1}).

Step 3-2. For 0≦i≦LN−1, let xᵢ≡|xᵢ|e^{jθ}^{ᵢ} and x′ᵢ denote an element of the input and output signals of the DPB module 314, respectively. The DPB process with parameter A_{P}>0 can be done according to equation (5) stated above.

Step 3-3. Perform digital clipping with a clipping ratio

$$γ = \frac{{T}_{th}}{\sqrt{E [ {‖ {x}^{′} ‖}^{2} ]}}$$

on x′=(x′₀,x′₁,Λ, x′_{LN-1}) to obtain x̅=( x̅₀, x̅₁,Λ, x̅_{LN-1}).

Step 3-4. Apply LN-point FFT on x̅ by using the LN-point FFT unit 318 to get the frequency-domain signal X̅=( X̅₀, X̅₁,Λ, X̅_{LN-1}).

Step 3-5. Filter out the out-of-band emission of the frequency-domain signal X̅ by setting X̅ᵢ=0 for i ∈{N, N+1,Λ, LN−1) to get frequency-domain signal \tilde{X}.

Step 3-6. Repeat Step 3-1 to Step 3-5 for N_{IT} times.

Step 3-7. The frequency-domain signal \tilde{X} is processed by the N-point IFFT unit 320 to generate the time-domain candidates \tilde{x}.

It should be noted that, if A_{P} equals zero, then RCF with DPB reduces to RCF only.

Furthermore, as mentioned above, SLM can be applied to improve error performance. Accordingly, the candidates can be obtained by using the method provided in Step 2-1 to Step 2-4, and, for example, the one of the time-domain candidates \tilde{x} with minimum peak-to-average power ratio can be chosen as the candidate or, in other situations, the one of the time-domain candidates \tilde{x} with minimum distortion might be chosen as the candidate used in the selective mapping technique.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for generating candidates used in turbo coded orthogonal frequency-division multiplexing system with selective mapping technique, wherein a user data is combined with a plurality of seeds to generate corresponding a plurality of message vectors, which is characterized in performing tail-biting turbo encoding on each of the message vectors to generate corresponding turbo codeword used for generating candidate, wherein the seed of each message vector is different from the seeds of other message vectors.

2. The method of claim 1, wherein the turbo codeword is generated by using steps including:
encoding the message vector ū with zero initial state by using an encoder of a first constituent code to get a final state
$${s}_{M} = {\sum }_{n = 0}^{M - 1} {A}^{( M - 1 ) - n} {Bu}_{n} ,$$
wherein the message vector ū={u₀,u₁,Λ,u_{M-1}} and uₙ is a binary k×1 vector at time n, a state-space representation of the first constituent code is sₙ₊₁=Asₙ+Buₙ, where sₙ₊₁ and sₙ are m×1 state vectors of the encoder at time n+1 and n, respectively, A is m×m state matrix, B is m×k control matrix, and m is the number of memory bits of the encoder of the first constituent code;
deriving a new initial state s′₀ from (A^{M}+Iₘ)s′₀=Σₙ₌₀^{M-1}A^{(M-1)-n}Buₙ=s_{M} with s′₀=s′_{M} and
$${s}_{M} = {\sum }_{n = 0}^{M - 1} {A}^{( M - 1 ) - n} {Bu}_{n} ,$$
where Iₘ is an m×m identity matrix;
encoding the message vector ū with the new initial state s′₀ to generate the codeword of the first constituent code;
encoding the message vector ū with initial state s′₀ by using an encoder of a second constituent code to generate the codeword of the second constituent code; and
generating the turbo codeword in accordance to the codeword of the first constituent code and the codeword of the second constituent code.

3. A method for generating candidates used in turbo coded orthogonal frequency-division multiplexing system with selective mapping technique, wherein a user data is combined with a plurality of seeds to generate corresponding a plurality of message vectors, including:
performing tail-biting turbo encoding on the message vectors to generate corresponding turbo codewords;
generating a plurality of frequency-domain symbol-sequences in accordance to the turbo codewords;
converting each of the frequency-domain symbol-sequences to corresponding one time-domain candidate; and
choosing one of the time-domain candidates as a candidate used in the selective mapping technique,
wherein the seed of each message vector is different from the seeds of other message vectors.

4. The method of claim 3, wherein the turbo codeword is generated by using steps including:
encoding the message vector ū with zero initial state by using an encoder of a first constituent code to get a final state
$${s}_{M} = {\sum }_{n = 0}^{M - 1} {A}^{( M - 1 ) - n} {Bu}_{n} ,$$
wherein the message vector ū={u₀,u₁,Λ,u_{M-1}} and uₙ is a binary k×1 vector at time n, a state-space representation of the first constituent code is sₙ₊₁=Asₙ+Buₙ, where sₙ₊₁ and sₙ are m×1 state vectors of the encoder at time n+1 and n, respectively, A is m×m state matrix, B is m×k control matrix, and m is the number of memory bits of the encoder of the first constituent code;
deriving a new initial state s′₀ from (A^{M}+Iₘ)s′₀=Σₙ₌₀^{M-1}A^{(M-1)-n}Buₙ=s_{M} with s′₀=s′_{M} and
$${s}_{M} = {\sum }_{n = 0}^{M - 1} {A}^{( M - 1 ) - n} {Bu}_{n} ,$$
and where Iₘ is an m×m identity matrix;
encoding the message vector ū with the new initial state s′₀ to generate the codeword of the first constituent code;
encoding the message vector ū with initial state s′₀ by using an encoder of a second constituent code to generate the codeword of the second constituent code; and
generating the turbo codeword in accordance to the codeword of the first constituent code and the codeword of the second constituent code.

5. The method of claim 3, wherein converts each of the frequency-domain symbol-sequences to corresponding one time-domain candidate including:
processing each of the frequency-domain symbol sequences by performing peak-to-average power reduction operation, including inverse fast Fourier transform operation, power compensation operation, clipper operation, fast Fourier transform operation and filtering operation, repeatedly.

6. The method of claim 5, wherein the power compensation operation is performed between the inverse fast Fourier transform operation and the clipper operation.

7. The method of claim 5, wherein the power compensation operation including:
compensating power loss by x′ᵢ=(|xᵢ|+Ap)e^{jθ}^{ᵢ}, 0≦i≦LN−1, Ap≧0, L is a positive integer;
wherein LN is a point number used for performing the inverse fast Fourier transform operation,
wherein x′ᵢ is an element of an output signal x′ obtained after performing power compensation operation on a signal xᵢ≡|xᵢ|e^{jθ}^{ᵢ}, and
wherein x=(x₀,x₁,Λ,x_{LN-1}).

8. The method of claim 3, wherein one of the time-domain candidates with minimum peak-to-average power ratio is chosen as the candidate.

9. The method of claim 3, wherein one of the time-domain candidates with minimum distortion is chosen as the candidate.

10. A method for performing peak-to-average power ratio reduction, comprising steps of:
performing a deliberate power boost by x′ᵢ=(|xᵢ|+Ap)e^{jθ}^{ᵢ}, 0≦i≦N−1, Ap≧0,
wherein x=(x₀,x₁,Λ,x_{N-1}), which is a time-domain OFDM symbol, N is a point number used for performing the inverse fast Fourier transform operation, and x′ᵢ is an element of an output signal x′ obtained after performing the deliberate power boost on a signal xᵢ≡|xᵢ|e^{jθ}^{ᵢ}.
